(19) United States
(12) Patent Application Publication
(10) Pub. No.: US 2008/0298767 A1
(43) Pub. Date: Dec. 4, 2008

(54) Method, medium and apparatus summarizing moving pictures of sports games

(75) Inventors: Jin-Guk Jeong, Yongin-si (KR); Eui-hyeon Hwang, Seongnam-si (KR); Seok-cheol Kee, Uiwang-si (KR); Ki-wan Eom, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/005,337

(22) Filed: Dec. 27, 2007

(30) Foreign Application Priority Data
May 30, 2007 (KR) 10-2007-0052916

(51) Int. Cl. H04N 5/93; G11B 27/00

(52) U.S. Cl. 386/52; 715/723

(57) ABSTRACT

Provided is a method and apparatus for summarizing a moving picture of a sports game. The method includes detecting play sections of the moving picture; calculating a degree of importance of each play section; and summarizing the moving picture including each play section using the degree of importance of each play section.

### CROSS-REFERENCE TO RELATED APPLICATIONS

This application claims the benefit of Korean Patent Application No. 10-2007-0052916, filed on May 30, 2007, in the Korean Intellectual Property Office, the disclosure of which is incorporated herein in its entirety by reference.

### BACKGROUND

1. Field

One or more embodiments of the present invention relate to a method, medium and apparatus summarizing moving pictures, and more particularly, to a method, medium and apparatus summarizing moving pictures of a sporting event including sports games such as baseball, soccer, tennis, volleyball or the like.

2. Description of the Related Art

Image reproducing apparatuses, such as personal video recorders (PVRs), reproduce moving pictures stored in storage devices so that users can view the moving pictures on display devices at a convenient time and location. Image reproducing apparatuses also decode encoded image data and output the decoded image data. With the development of networks, digital storage devices, and image compression and restoration technologies, the use of image reproducing apparatuses storing digital images in storage devices before reproducing the stored digital images has increased greatly.

When a sporting event video that lasts more than two hours, such as a soccer game, is recorded, a user needs to be able to easily and quickly select, edit, and reproduce a desired scene of the sporting event for a review of key events such as goals and shooting scenes. Such an ability, which enables a user to easily and quickly grasp the contents of a moving picture, is called an image summary.

According to a conventional technique of summarizing a moving picture of a sports game, key events, such as offenses, swift attacks, or shots on goal are detected using information, such as colors, motions, and sounds, extracted from a moving picture of a sports game. Then, the moving picture is summarized based on the detected events. Alternatively, a moving picture may be divided into play shots and non-play shots and a summary moving picture including only the play shots may be generated.

U.S. Patent Publication No. 20030081937 entitled “Summarization of Video Content” discloses a technology for detecting play sections using statistical values included in color information and creating a summarization including the play sections, or controlling summarization levels by a section in which an audio level increases, a score is changed or the like.

U.S. Patent Publication No. 20060112337 entitled “Method and Apparatus for Summarizing Sports Moving Picture” discloses a technology for extracting video/audio events based on a shot, calculating a degree of importance of the shot-based on video/audio events, arranging the video/audio events in order of their importance, and summarizing the video/audio events.

However, the conventional summarization techniques cannot control a total time of the summarization period. In particular, U.S. Patent Publication No. 20030081937 suggests controlling just three summarization levels, and does not provide a solution when a user wishes to summarize video content to total no more than a desired period of time.

Meanwhile, since a key sports event such as a home-run generally includes several shots, if U.S. Patent Publication No. 20060112337 calculates the degree of importance of the shot based on video/audio events, the summarization of shot based on video/audio events may result in a partially cut event section.

### SUMMARY

One or more embodiments of the present invention provide a method, medium and apparatus summarizing a moving picture of a sports game within a desired period of time by detecting play sections, dividing the moving picture of the sports game into various play sections and calculating a degree of importance of each play section based on video and/or audio events.

Additional aspects and/or advantages will be set forth in part in the description which follows and, in part, will be apparent from the description, or may be learned by practice of the invention.

According to an aspect of the present invention, there is provided a method of summarizing a moving picture of a sports game, the method comprising: detecting play sections of the moving picture; calculating a degree of importance of each play section; and summarizing the moving picture including each play section using the degree of importance of each play section.

According to another aspect of the present invention, there is provided a computer-readable recording medium on which a program for executing the method of summarizing a moving picture of a sports game.

According to another aspect of the present invention, there is provided an apparatus for summarizing a moving picture of a sports game, the apparatus comprising: a play section detecting unit detecting play sections of the moving picture; a calculating unit calculating a degree of importance of each play section; and a summarizing unit summarizing the moving picture including each play section using the degree of importance of each play section.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an apparatus summarizing a moving picture of a sports game, according to an embodiment of the present invention;

FIG. 2A through 2D are images illustrating play start points of play sections of various sports games, according to an embodiment of the present invention;

FIG. 3 is a block diagram of an importance calculating unit illustrated in FIG. 1; and

FIG. 4 is a flowchart illustrating a method summarizing a moving picture of a sports game, according to an embodiment of the present invention.

### DETAILED DESCRIPTION OF EMBODIMENTS

Reference will now be made in detail to embodiments, examples of which are illustrated in the accompanying drawings, wherein like reference numerals refer to the like elements throughout. Embodiments are described below to explain the present invention by referring to the figures.

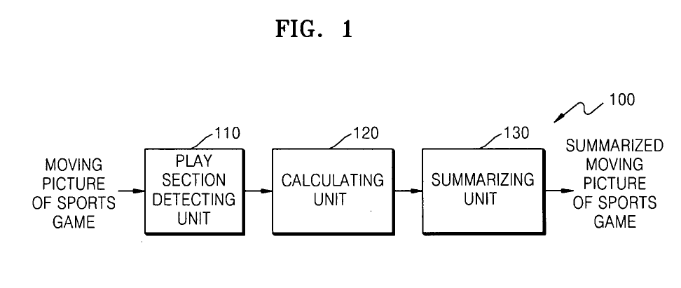

FIG. 1 is a block diagram of an apparatus 100 summarizing a moving picture of a sports game, according to an embodiment of the present invention. Referring to FIG. 1, the apparatus 100 may include, for example, a play section detecting unit 110, a calculating unit 120, and a summarizing unit 130.

The play section detecting unit 110 may detect play sections from moving pictures of sports games having a non-continuous play structure including such events as baseball, tennis or volleyball games. A play section may include, for example, a play starting point such as a pitching shot in a baseball game or a serve shot in tennis or volleyball games, and a play ending point such as a close-up shot taken of something other than the game, e.g., a close-up shot of one or more spectators. A non-play section may include a variety of other images including a commercial break, a player interview, or a conversation between one or more commentators.

Other sporting events such as a soccer game have a continuous play structure in which play is generally not interrupted for relatively long periods of time. However, even in games having a continuous play structure, non-play sections typically exist and include activities for which the soccer game is usually interrupted, such as a half-time intermission or when a referee blows his whistle and stops play because of a penalty.

In more detail, the moving picture of the sports game (hereinafter the “game video”) may be divided into a play section during which the game is being played and a break section during which an element other than the game takes place. The play section generally varies depending on the nature of the sports game. For example, the play section of a baseball game may begin, for example, with a frame including a pitcher who throws a ball and may end with a frame including a close-up scene of a fielder who grips the base ball after catching a hit by the batter. The play section of a tennis or volleyball game may begin, for example, with a frame including a player who serves a ball and may end with a frame including a close-up scene after an offensive period of play is over.

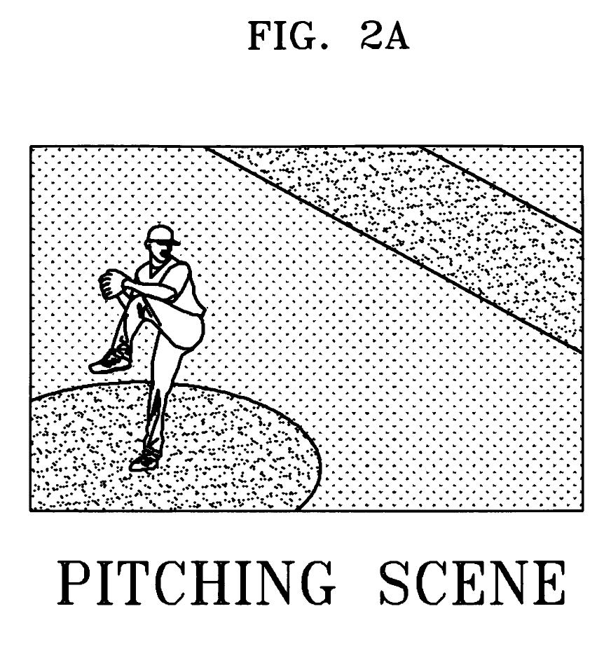

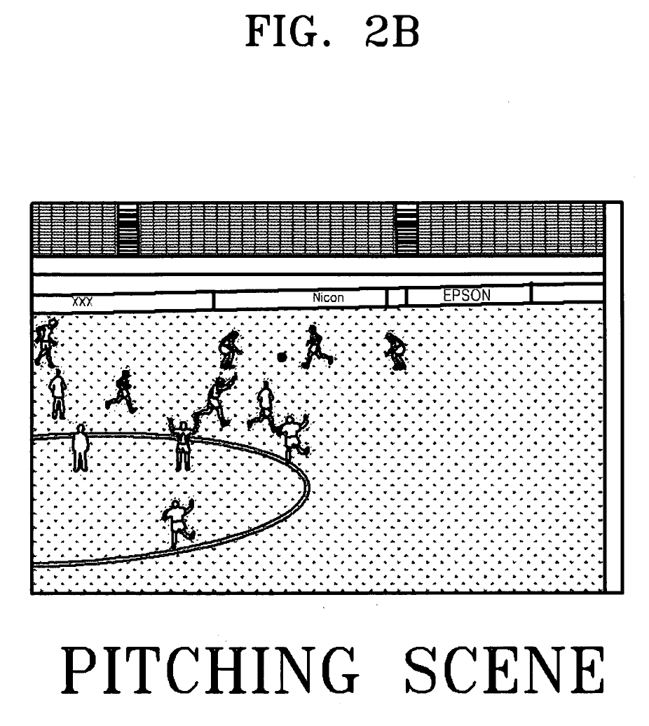

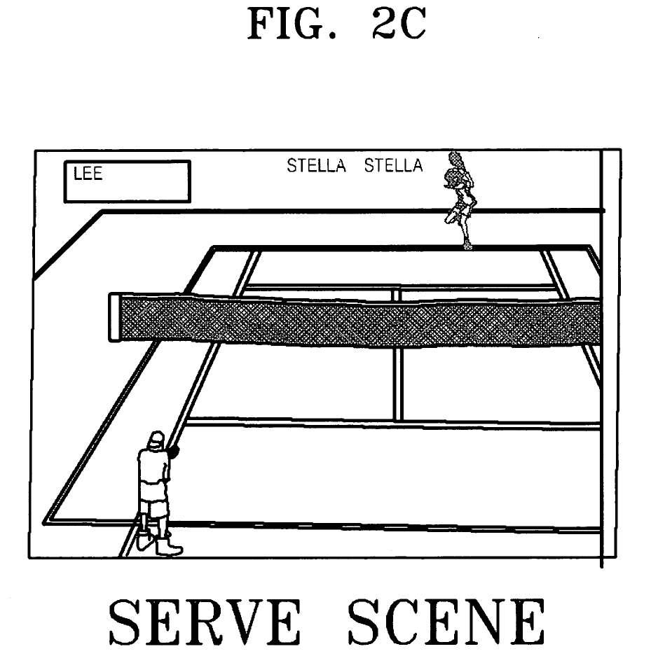

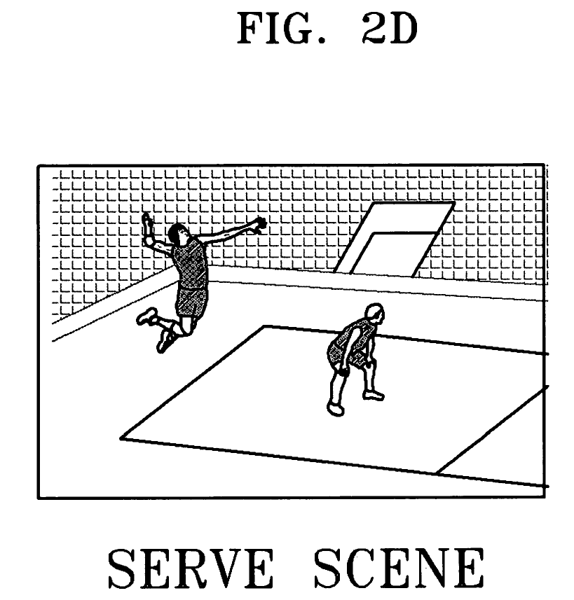

A method detecting play sections for a variety of sports games will be described with reference to FIGS. 2A through 2D.

The calculating unit 120 may calculate, for example, a degree of importance for each play section of the sports game detected in the detecting unit 110. The calculated degree of importance may be used to generate a moving picture summary having an arbitrary duration, e.g., a duration lasting a desired time, which may be input by a user. The calculating unit 120 may detect video and audio events included in the game video, and may determine a weight allocated to each video and audio event in order to calculate the degree of importance of each play section.

The summarizing unit 130 may summarize the game video, including each play section, based on the importance calculated in the calculating unit 120. If the user inputs a desired duration for the summarized moving picture, the play sections are generally included in the moving picture in the order of importance so that a total reproduction time for the summarized moving picture does not exceed the desired duration input by the user. For example, play sections may be ranked from most to least important and then the ranked play sections are included in the moving picture in order from most to least important until the desired duration as input by the user is achieved.

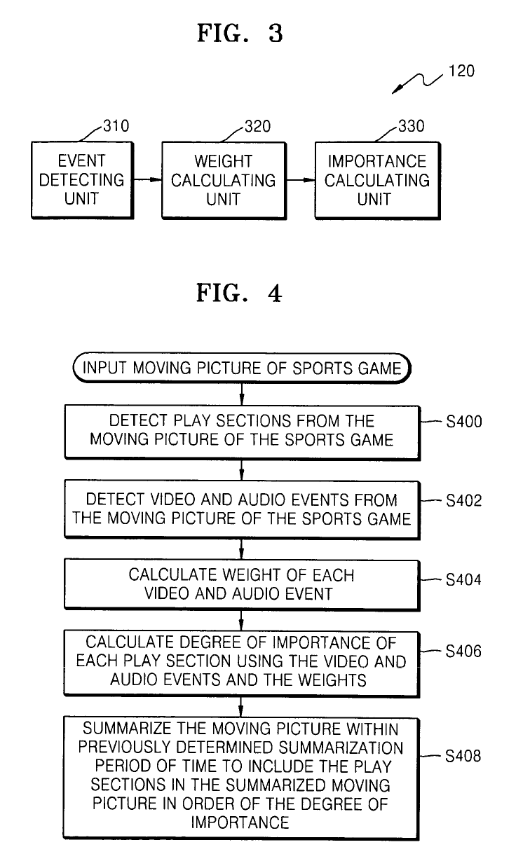

FIG. 2A through 2D are images for illustrating play start points of play sections for various sports games, according to an embodiment of the present invention. FIG. 2A is an image illustrating a pitching scene as a play start point for a baseball game. FIG. 2B is an image illustrating a long view scene, as opposed to a close-up scene, as a play start point of a soccer game. A long view scene typically refers to an image that is captured from a long distance away with respect to the ball. FIG. 3C is an image illustrating a serve scene as a play start point of a tennis game. FIG. 3D is an image illustrating a serve scene as a play start point of a volleyball game.

Although not shown, a play end point of a baseball, soccer, tennis, or volleyball game may be a close-up scene of a sports game.

As an example, a method of detecting the play start point from a moving picture of a baseball, tennis or volleyball game may detect the play start point using a previously determined model based on a support vector machine (SVM), and then an online model reflecting the feature of each stream of the moving picture. In particular, a difference between each stream of the moving picture and the online model may be compared in order to detect the play start point. When the play start point is detected, an average value of the feature of each stream may be determined to update the online model.

An edge distribution may be used to verify the previously determined model using the SVM. When a data segment is input with regard to online model learning, clustering may be performed immediately in order to reduce the time required for a later clustering period. The online model may include, for example, the edge distribution and a high-saturation-value (HSV) histogram. The difference between moving picture data and the online model may be calculated, for example, using a weighted Euclidean distance (WED) of the edge distribution and HSV histogram.

As another example, a method of detecting the play start point from a moving picture of a soccer game may detect the play start point using a close-up detection algorithm, since the play section generally contains shots other than close-up shots. A field color candidate may be extracted from a game video using a dominant color. The field color candidate and a previously modeled field color may be compared, and if a difference between the field color candidate and the previously modeled field color is greater than a threshold color, the field color candidate may be determined as the close-up shot. If the difference is smaller than the threshold color, the field color candidate may be determined as the field color. If a ratio of a field color of a space window while the space window slides is smaller than the threshold color, the field color may be determined as the close-up shot.

Referring to the above example, since a close-up shot is determined as the play end point of the moving picture of the soccer game, the close-up detection algorithm may be used. However, a frame that is to be examined is input in the moving picture of the soccer game, whereas a representative play start frame of the baseball, tennis or volleyball game may be used to extract the field color in order to examine a current frame.

FIG. 3 is a block diagram of the importance calculating unit 120 illustrated in FIG. 1. Referring to FIG. 3, the importance calculating unit 120 may include, for example, an event detecting unit 310, a weight calculating unit 320, and an importance calculating unit 330.

The event detecting unit 310 may detect at least one of video and audio events from the game video. The game video may include a plurality of video and audio events.

For example, a moving picture of a soccer game may include, for example, a plurality of video events including close-up shots, penalty shots, caption change shots, replay shots, crowd shots, and video events by a learning model, and a plurality of audio events including audio energy, key words such as score, goal, shot-on-goal, goal-scored, or the like, and audio events by the learning model.

The moving picture of a baseball game may include, for example, a plurality of video events including a length of a play section, replay shots, crowd shots, and a video event by a learning model, and a may also include a plurality of audio events including audio energy, key words such as home-run, hit, strike-out, or the like, and audio events by the learning model.

The moving picture of a tennis or volleyball game may include, for example, a plurality of video events including a length of a play section, replay shots, crowd shots, and video events by a learning model, and a plurality of audio events including audio energy, key words such as ace, match-point or the like, and audio events by the learning model.

As another example, a close-up detection algorithm may be used to detect a video event.

As another example, a penalty shot is output as a binary image by binary processing a frame image. This binary processing will now be described.

The frame image may be divided into N×N blocks (e.g., where N is 16). A threshold value T of each of the N×N blocks with respect to a brightness value Y may be determined, for example, according to Equation 1 below.

$$T = \frac{( {\sum }_{i = 0}^{N \times N} Y ( i ) )}{N \times N} \times a \qquad Equation 1$$

wherein “a” denotes a brightness threshold constant that is 1.2 in the present embodiment.

Next, the brightness value Y of a pixel of each block may be compared with the threshold value T of each block. If the brightness value Y is greater than the threshold value T of each block, 255 may be allocated to the frame image. In contrast, if the brightness value Y is smaller than the threshold value T of each block, 0 may be allocated to the frame image in order to generate the binary image. A white area to which 255 is allocated may be extracted from the binary image. The white area may be Hough transformed, for example. A perpendicular area is detected as a result of the Hough transformation of the white area. In accordance with Equation 1, the white area may include pixels having the brightness value as 1.2 times an average brightness value of the image. According to the Hough transformation, when the number of points having the same inclination of a perpendicular line between points is greater than a specific value, these points may be detected as the perpendicular area. The perpendicular area may be used to determine whether the frame image is a penalty frame. Since the perpendicular lines of the field area and the penalty area generally have different inclinations, an inclination of a perpendicular line corresponding to a penalty line may be used to determine whether the frame image is the penalty frame.

As another example, the length of the play section may be calculated using a difference between a play start point detected using one of the techniques of detecting the play start point described herein, and a play end point may be detected using one of the techniques of detecting a close-up shot described herein.

As another example, a caption change shot may be detected using a “method of detecting and recognizing an important caption,” for example, as described in Korean Patent Application No. 2006-0018691.

As another example, a crowd shot may be detected based on the fact that a crowd shot typically includes many edges. The crowd shot may be detected, for example, by extracting an edge density and calculating a variance of the edge density.

As another example, a learning-based method such as a hidden Markov model (HMM) may be used to detect a video event suitable for the HMM, after learning a shot change in advance of an important scene.

As another example, an audio event may be detected based on audio energy by obtaining short time energy and comparing an average value of each shot and a threshold value.

As another example, the audio event may be detected based on the learning model by learning an important audio event (goal, home-run, score or the like) section using the features of a Mel frequency cepstral coefficient (MFCC), spectral centroid, spectral rolloff, spectral flux, zero-crossing rate (ZCR), short time energy, or the like, and the learning models such as the SVM, HMM, or the like.

The weight calculating unit 320 may calculate a weight of each of the detected events using a probability-based Bayes theory. When an i^{th} video or an audio event Eᵢ appears, a probability P(I|Eᵢ) is that the i^{th} video or the audio event Eᵢ is an important event I that is to be included in a summary and is proportional to Bayes theory. Thus, the weight Wᵢ of the i^{th} video or the audio event Eᵢ may be calculated, for example, according to Equation 2 below.

$${W}_{i} = \frac{P ( {E}_{i} \vert I )}{{\sum }_{x} P ( {E}_{x} \vert I )} \qquad Equation 2$$

wherein, an equation corresponding to a denominator may be added for normalization.

The importance calculating unit 330 may calculate a degree of importance of each play section using at least one of the detected events and the weight of each event.

As an example of calculating the degree of importance using the weight, the length of the play section, the audio event by the learning model, and the audio energy in the moving picture of the baseball game, the degree of importance Wᵢ of an i^{th} play section will now be described below.

An importance value of each event may be calculated.

Supposing that the i^{th} play section is between Startᵢ and Endᵢ, and the maximum length of the whole lengths of the play sections is Max_{L}, the importance value of the length F(L) of the play section may be calculated, for example, according to Equation 3 below.

$$F ( L ) = \frac{{End}_{i} - {Start}_{i}}{{Max}_{L}} \qquad Equation 3$$

Supposing that average audio energy is Aₑ, and the maximum audio energy average of the whole play sections is Max_{A}, the importance value of the audio energy F(A) may be calculated according to Equation 4 below.

$$F ( A ) = \frac{{A}_{e}}{{Max}_{A}} \qquad Equation 4$$

Finally, when the audio event F(E) by the learning model is detected, it is set to 1.0, and when it is not detected, it is set to 0.3, for example.

The importance value of each event may be used to calculate the degree of importance Wᵢ of an i^{th} play section.

Supposing that probabilities of when the length of the play section in learning data including important events that are to be included in the moving picture summary is greater than a predetermined threshold value, of the audio energy is greater than the predetermined threshold value, and of the audio event occurs are P(L|I), P(A|I), and P(E|I), respectively, the degree of importance Wᵢ of an i^{th} play section may be calculated, for example, according to Equation 5 below.

$${W}_{i} = \frac{P ( L \vert I )}{P} \times F ( L ) + \frac{P ( A \vert I )}{P} \times F ( A ) + \frac{P ( E \vert I )}{P} \times F ( E ) ; P = P ( L \vert I ) + P ( A \vert I ) + P ( E \vert I ) \qquad Equation 5$$

As another example, a soccer game may be analyzed in the same manner as the baseball game, except that the games use different video events. In more detail, because the length of a play section in the moving picture of a soccer game is not typically as relevant, and because a close-up shot of a player or of the crowd is typically included in the moving picture of the soccer game when an important event occurs, the number of close-up shots may be used to calculate the degree of importance of a video event.

FIG. 4 is a flowchart illustrating a method summarizing a moving picture of a sports game, according to an embodiment of the present invention. Referring to FIG. 4, a game video may be received and play sections of the video may be detected in Operation 400, e.g., by an apparatus summarizing moving pictures of sports games. Specific video and audio events may be detected from the game video in Operation 402. A weight of each video and audio event may be calculated in Operation 404, and a degree of importance of each play section may be calculated using the video and audio events and the weights in Operation 406. The moving picture may be summarized within a summary period of time input by a user so that the play sections are included in the summarized moving picture based on the order of importance of the play sections in Operation 408.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as media carrying or including carrier waves, as well as elements of the Internet, for example. Thus, the medium may be such a defined and measurable structure including or carrying a signal or information, such as a device carrying a bitstream, for example, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

According to one or more embodiments of the present invention, play sections may be detected from a moving picture of a sports game, a degree of importance of each play section may be calculated, and the game video including all the play sections may be summarized based on the importance of each play section. One or more embodiments of the present invention enable a scalable summary capable of including each play section in the summarized moving picture within a desired period of time input by a user after all play sections are arranged in an order based on the degree of importance of the play sections. Consequently, a play section may be generated based on the summary and an important event is prevented from being missed in the summarized moving picture.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of summarizing a moving picture of a sports game, the method comprising:
detecting play sections of the moving picture;
calculating a degree of importance of each play section; and
summarizing the moving picture including each play section using the degree of importance of each play section.

2. The method of claim 1, wherein, in the summarizing of the moving picture, all play sections are included in the moving picture in an order of the degree of importance according to a previously determined summarization period of time.

3. The method of claim 1, wherein the calculating of the degree of importance of each play section comprises:
detecting video events and/or audio events of the moving picture;
calculating a weight of each event; and
calculating the degree of importance of each play section using at least one of the events and the weight of each event.

4. The method of claim 1, wherein, in the detecting of the play sections of the moving picture, a play start point and a play end point of the moving picture are detected.

5. The method of claim 1, wherein, in the detecting of the play sections of the moving picture, a close-up detection algorithm is used to detect the plays sections of the moving picture.

6. The method of claim 3, wherein, in the calculating of the weight of each event, the weight is calculated using a probability-based Bayes theory.

7. The method of claim 3, wherein the video events comprise at least one of a close-up shot, a length of each play section, a caption change shot, a replay shot, a crowd shot, a penalty area shot, and a video event by a learning model.

8. The method of claim 3, wherein the audio events comprise at least one of audio energy, a key word, and an audio event by the learning model.

9. A computer readable recording medium storing a program for executing the method of claim 1.

10. An apparatus for summarizing a moving picture of a sports game, the apparatus comprising:
a play section detecting unit detecting play sections of the moving picture;
a calculating unit calculating a degree of importance of each play section; and
a summarizing unit summarizing the moving picture including each play section using the degree of importance of each play section.

11. The apparatus of claim 10, wherein the summarizing unit summarizes the moving picture to include all play sections in an order of the degree of importance according to a previously determined summarization period of time.

12. The apparatus of claim 10, wherein the calculating unit comprises:
an event detecting unit detecting video events and/or audio events of the moving picture;
a weight calculating unit calculating a weight of each event; and
an importance calculating unit calculating the degree of importance of each play section using at least one of the events and the weight of each event.

13. The apparatus of claim 10, wherein the play section detecting unit detects a play start point and a play end point of the moving picture in order to detect the play sections.

14. The apparatus of claim 10, wherein the play section detecting unit uses a close-up detection algorithm to detect the plays sections of the moving picture.

15. The apparatus of claim 12, wherein the weight calculating unit calculates the weight of each event using a probability-based Bayes theory.

16. The apparatus of claim 12, wherein the event detecting unit detects the video events comprising at least one of a close-up shot, a length of each play section, a caption change shot, a replay shot, a crowd shot, a penalty area shot, and a video event by a learning model.

17. The apparatus of claim 12, wherein the event detecting unit detects the audio events comprising at least one of audio energy, a key word, and an audio event by the learning model.
